(19) United States
(12) Patent Application Publication
(10) Pub. No.: US 2018/0099879 A1
(43) Pub. Date: Apr. 12, 2018

(54) WATER TREATMENT SYSTEM AND METHOD OF PURIFYING WATER

(71) Applicants: Abdullah ALGHAFIS, Whitehall, PA (US); Ahmed Alshwairekh, Whitehall, PA (US)

(72) Inventors: Abdullah ALGHAFIS, Whitehall, PA (US); Ahmed Alshwairekh, Whitehall, PA (US)

(21) Appl. No.: 15/839,437

(22) Filed: Dec. 12, 2017

(51) Int. Cl. C02F 1/44; B01D 61/00; B01D 63/08

(52) U.S. Cl. CPC C02F 1/445; B01D 61/005; B01D 2313/12; C02F 2201/007; B01D 2313/14; B01D 63/082

(57) ABSTRACT

A water treatment system with a vessel that contains saline water and a membrane module with a first planar semi-permeable membrane, a second planar semi-permeable membrane substantially parallel to the first planar semi-permeable membrane, and at least one elongated membrane with an elongated cavity sandwiched between the first and the second planar semi-permeable membranes, wherein water molecules in the saline water are permeated through said membranes when a draw solution is passed through the elongated cavity; and a method of forming a purified water stream with the water treatment system.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND OF THE INVENTION

### Technical Field

The present invention relates to a water treatment system and a method of forming a purified water stream with the water treatment system.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Approximately 70% of earth is covered with water. About 97% of this amount is saline water and therefore cannot be directly consumed. A solution to the shortage of water in many places in the world caused by an enormous rise in population and vast industrialization can be achieved through desalinating and purifying seawater or other sources of saline water. Various methods and techniques have been investigated to economically desalinate and purify seawater to produce freshwater for various residential and industrial applications. Among them, reverse osmosis, forward osmosis, and nanofiltration have become popular due to their effectiveness in removing low molecular weight solutes, such as small organic compounds and ions. However, water extraction techniques via reverse osmosis and nanofiltration are energy-intensive and may not always be the best choices from economical aspects. For example, reverse osmosis processes consume a large amount of energy to pressurize saline water to pass through a membrane to form freshwater. One way to reduce the energy consumption of reverse osmosis processes is to use membranes with large pore sizes. However, such membranes may not efficiently filter toxic contaminants present in saline water, for example, boron compounds, arsenic compounds, etc. that are present in seawater.

To reduce the energy consumption while still using membranes with sub-micron pores, forward osmosis processes have been investigated and utilized. In a forward osmosis process, a semi-permeable membrane separates a highly concentrated draw solution and a feed solution, wherein water molecules permeate through the semi-permeable membrane from the feed solution to the draw solution, due to the osmotic pressure difference between the draw solution and the feed solution. After that, the draw solute is separated from the draw solution and freshwater is produced. Forward osmosis systems generally include two adjacent zones that are separated by a semi-permeable membrane, wherein a first zone contains saline water and a second zone contains a draw solution that is usually not flowing or moving. Accordingly, water molecules flow from the saline water to the draw solution through the semi-permeable membrane.

In view of the forgoing, one objective of the present disclosure is to provide a water treatment system with a vessel that contains saline water and a membrane module with a first planar semi-permeable membrane, a second planar semi-permeable membrane substantially parallel to the first planar semi-permeable membrane, and at least one elongated membrane with an elongated cavity sandwiched between the first and the second planar semi-permeable membranes, wherein water molecules in the saline water permeate through said membranes when a draw solution is passed through the elongated cavity. Another objective of the present disclosure relates to a method of forming a purified water stream with the water treatment system.

### BRIEF SUMMARY OF THE INVENTION

According to a first aspect, the present disclosure relates to a water treatment system, including i) a vessel with an internal cavity, a saline water inlet, and a brine outlet, wherein the vessel contains a saline water, ii) a membrane module that is disposed in the internal cavity and submerged in the saline water, wherein the membrane module comprises a) a first planar semi-permeable membrane, b) a second planar semi-permeable membrane that is placed substantially parallel to the first planar semi-permeable membrane, c) at least one elongated membrane with an elongated cavity, wherein the at least one elongated membrane is sandwiched between the first and the second planar semi-permeable membranes, iii) a draw solution reservoir located upstream of the vessel and fluidly connected to an inlet of the elongated cavity via a draw solution line, wherein the draw solution reservoir delivers a draw solution comprising a draw solute to the elongated cavity, wherein water molecules present in the saline water permeate through the first planar semi-permeable membrane, the second planar semi-permeable membrane, and the at least one elongated membrane to form a mixed water stream comprising water and the draw solute in the elongated cavity.

In one embodiment, the water treatment system further includes a separator that is located downstream of the vessel and fluidly connected to an outlet of the elongated cavity via a mixed water line, wherein the separator separates at least a portion of the draw solute from the mixed water stream.

In one embodiment, the separator comprises at least one of a microfiltration membrane, an ultrafiltration membrane, a nanofiltration membrane, and a centrifugal separator.

In one embodiment, the at least one elongated membrane has a coil shape.

In one embodiment, the at least one elongated membrane has a zigzag shape.

In one embodiment, the first and the second planar semi-permeable membranes are substantially the same.

In one embodiment, a distance between the first and the second planar semi-permeable membranes is in the range of 2 to 50 mm.

In one embodiment, each of the first and the second planar semi-permeable membrane has a thickness of 1 to 20 mm.

In one embodiment, the at least one elongated membrane has a thickness of 1 to 20 mm.

In one embodiment, the elongated cavity is cylindrical with a diameter in the range of 0.1 to 5 mm.

In one embodiment, the draw solute is at least one compound selected from the group consisting of ammonia, aluminum sulfate, glucose, fructose, sucrose, ethanol, urea, and ethylene glycol.

In one embodiment, each of the first planar semi-permeable membrane, the second planar semi-permeable membrane, and the at least one elongated membrane comprises at least one polymer selected from the group consisting of polyamide, polystyrene, polyethersulfone, and polysulfone.

In one embodiment, the water treatment system further includes a pump disposed in the internal cavity to pressurize the saline water.

In one embodiment, the water treatment system further includes a saline water tank that is located upstream of and fluidly connected to the saline water inlet via a saline water line, and a brine tank that is located downstream of and fluidly connected to the brine outlet via a brine line.

According to a second aspect, the present disclosure relates to a method of forming a purified water stream with the water treatment system involving, i) delivering the draw solution to the elongated cavity, wherein water molecules present in the saline water permeate through the first planar semi-permeable membrane, the second planar semi-permeable membrane, and the at least one elongated membrane to form a mixed water stream comprising water and the draw solute in the elongated cavity, ii) separating the draw solute from the mixed water stream, thereby forming the purified water stream.

In one embodiment, the draw solution is delivered to the elongated cavity with a flow rate of 0.1 mL/min to 10 L/min.

In one embodiment, the draw solution is delivered to the elongated cavity in a continuous fashion.

In one embodiment, the method further involves recycling a portion of the draw solute to the draw solution reservoir.

In one embodiment, the method further involves pressurizing the saline water after the delivering.

In one embodiment, the saline water is pressurized to a hydraulic pressure of 30 to 1,500 psi.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a flow diagram of a water treatment system.

FIG. 2 illustrates a vessel with a membrane module disposed therein.

FIG. 3A is an isotropic view of the membrane module with four straight elongate membranes.

FIG. 3B is a top view of the membrane module with four straight elongate membranes.

FIG. 3C is a side view of the membrane module with four straight elongate membranes.

FIG. 3D is a top view of the membrane module with two U-shape elongate membranes.

FIG. 3E is a top view of the membrane module with four zigzag shape elongate membranes.

FIG. 3F is a top view of the membrane module with four coil shape elongate membranes.

### DETAILED DESCRIPTION OF THE EMBODIMENTS

Referring now to the drawings, wherein like reference numerals designate identical or corresponding parts throughout the several views.

According to a first aspect, the present disclosure relates to a water treatment system 100. The term “water treatment system” as used in this disclosure refers to a set of equipment that removes molecules and ions from saline water (e.g. sea water, blood etc.) to form purified water or water of lower salinity, e.g. freshwater or drinking water.

Accordingly, the water treatment system 100 includes a vessel 102 with an internal cavity, and a saline water inlet 202 that is configured to load the internal cavity with saline water 128s, and a brine outlet 204 that is configured to discharge brine 130s from the internal cavity. Alternatively, the saline water inlet 202 or the brine outlet 204 may be utilized to load/unload other liquids, e.g. blood.

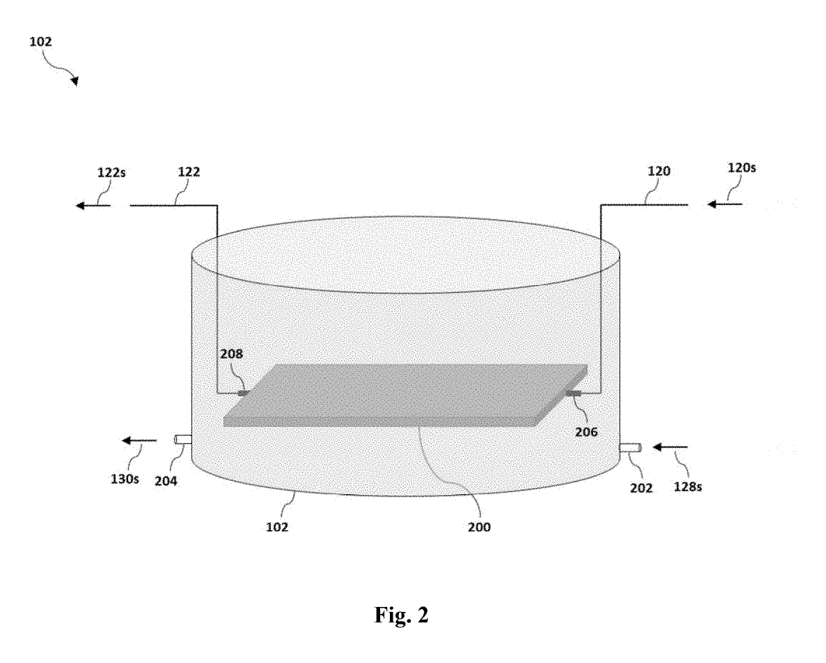

The vessel 102 may have a rectangular geometry, preferably a spherical geometry, more preferably a cylindrical geometry, as shown in FIG. 2, and may be made of a material including, but not limited to, stainless steel, galvanized steel, mild steel, aluminum, copper, brass, bronze, iron, nickel, titanium, quartz, glass, polypropylene, polyvinyl chloride, polyethylene, and/or polytetrafluoroethylene. Preferably, the vessel 102 may be made of stainless steel such as type 304, 316, or 316L stainless steel. Alternatively, the vessel 102 may be made of an austenitic chromium-nickel stainless steel. The vessel 102 may have a wall thickness of 0.1 to 3 cm, preferably 0.1 to 2 cm, more preferably 0.2 to 1.5 cm. The volume of the internal cavity of the vessel 102 may be different according to the application of the water treatment system 100. For example, for small scale or benchtop treatment, e.g. kitchen water purifier or in dialysis applications as an artificial kidney, the internal cavity may have a volume of 10 mL-5 L, preferably 100 mL-2 L, more preferably 200 mL-1 L. For pilot plant water treatment applications, the internal cavity may have a volume of 5 L-1,000 L, preferably 7 L-500 L, more preferably 8 L-200 L. For industrial-scale water treatment plants, the internal cavity may have a volume of 1,000 L-500,000 L, preferably 20,000 L-400,000 L, more preferably 40,000 L-100,000 L. Additionally, the vessel 102 may be equipped with a safe valve to prevent excessive gas pressure in the overhead section of the vessel.

The water treatment system 100 further includes a membrane module 200 that is disposed in the internal cavity and submerged in the saline water, as shown in FIG. 2, in order to desalinate the saline water 128s via a forward osmosis.

The term “saline water” as used herein preferably refers to water with a total dissolved solid (TDS) content of 0.05 wt % to 8 wt %, preferably 0.1 wt % to 6 wt %, preferably 0.5 wt % to 5.0 wt %, relative to the total weight of the saline water. Accordingly, the term “saline water” may refer to various types of water including ocean or sea water, lake water, river water, etc. Salts that are present in the saline water that may be removed with the water treatment system of the present disclosure may include, without limitation, cations such as sodium, magnesium, calcium, potassium, ammonium, and iron, and anions such as chloride, bicarbonate, carbonate, sulfate, sulfite, phosphate, iodide, nitrate, acetate, citrate, fluoride, and nitrite. In addition, the term “purified water” as used in this disclosure refers to water with a total dissolved solid (TDS) content of less than 0.05 wt %, preferably less than 0.04 wt %, preferably less than 0.03 wt %, relative to the total weight of the saline water. The term “purified water” and “freshwater” are identical and may be used interchangeably throughout this disclosure.

In “forward osmosis”, a draw solution with a high osmotic pressure draws water molecules from a feed solution, e.g. saline water, to the draw solution. A pressure may also be applied to the saline water to enhance the osmotic pressure. Accordingly, water molecules present in the saline water permeate through the semi-permeable membrane and are mixed with the draw solution, thus leaving the solute (dissolved salt) behind. Forward osmosis may remove many types of molecules and ions from the saline water, including salts and bacteria, and thus may be utilized in both industrial processes and the production of potable water. To be selective, the semi-permeable membrane may not allow large molecules or ions through the pores (holes), but may allow smaller components of the solution (such as water molecules) to pass freely. Preferably, the dissolved salts that may be removed via forward osmosis may include, without limitation, sodium chloride, ammonium carbonate, ammonium bicarbonate, and ammonium carbamate, calcium carbonate, calcium bicarbonate, calcium phosphate, calcium fluoride, calcium silicate, and/or magnesium hydroxide.

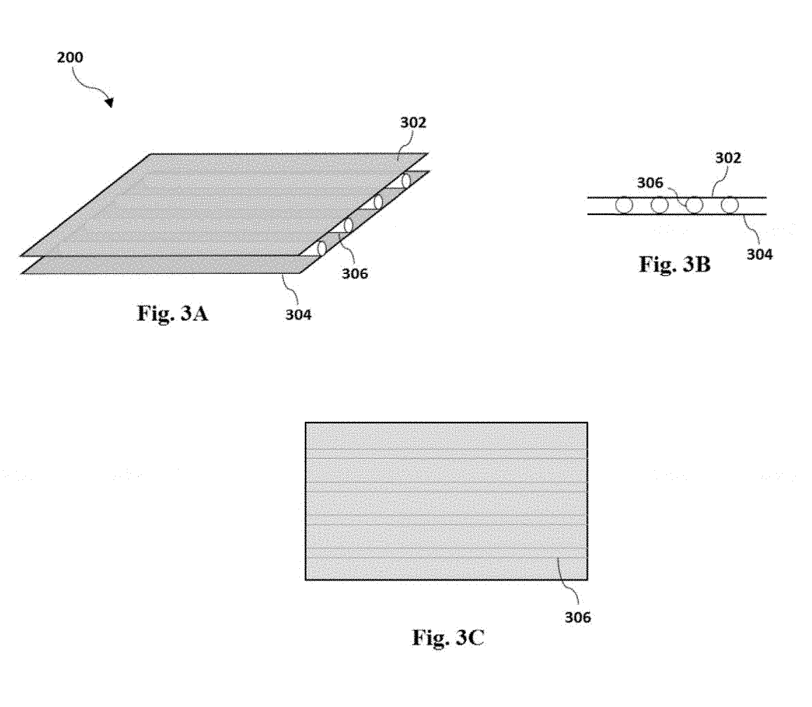

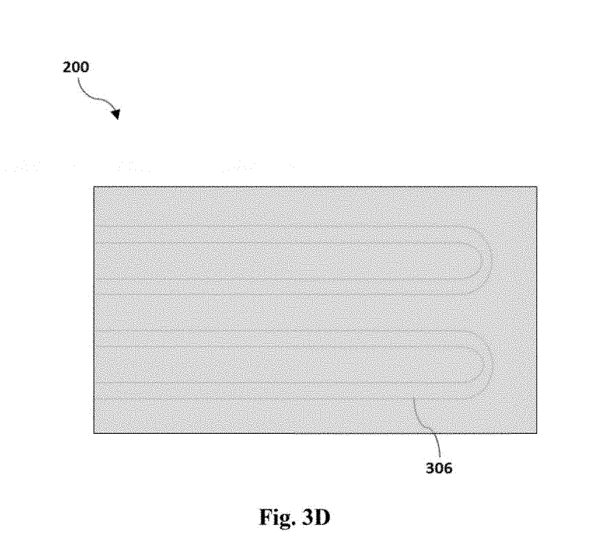

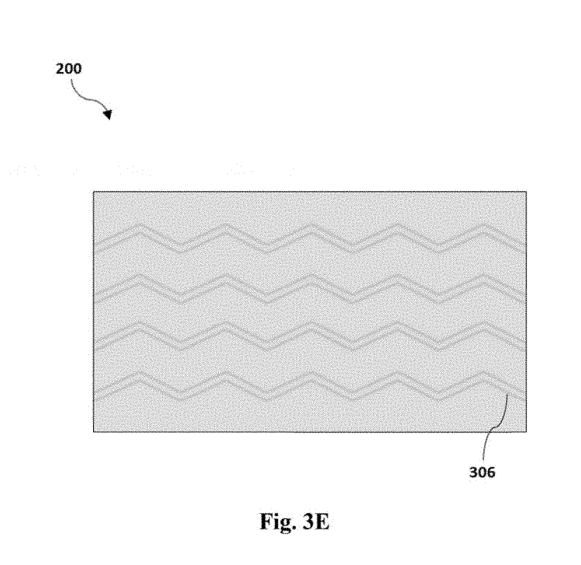

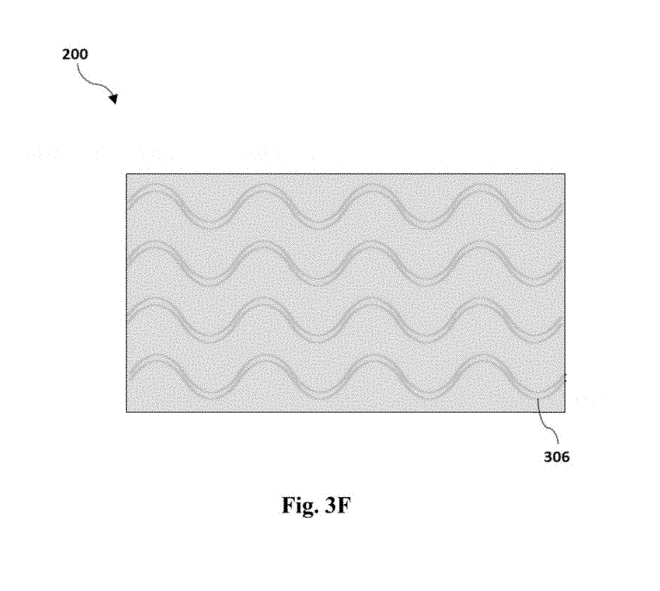

The membrane module 200 includes a first planar semi-permeable membrane 302, a second planar semi-permeable membrane 304 that is placed substantially parallel to the first planar semi-permeable membrane, and at least one elongated membrane 306 sandwiched between the first and the second planar semi-permeable membranes, as shown in FIGS. 3A and 3B.

The term “semi-permeable membrane” as used herein refers to a porous material that can separate/filter at least a portion of the components present in the saline water that passes through the porous material. In addition, the term “planar” refers to a flat shape of the semi-permeable membrane. Also, the term “elongated membrane” as used in this disclosure refers to a semi-permeable membrane that serves as a spacer between the first and the second planar semi-permeable membranes that has an elongated cavity for passing a draw solution therethrough. The elongated membrane may preferably be made of the same material as in the first and the second planar semi-permeable membranes, although in some alternative embodiments, the elongated membrane may be made of a different material than that of the first and the second planar semi-permeable membranes.

The elongate membrane 306, the first planar semi-permeable membrane 302, and the second planar semi-permeable membrane 304 may be made of organic polymers, organic co-polymers, mixtures of organic polymers, or organic polymers mixed with inorganics. Exemplary organic polymers may include, without limitation, polysulfones; poly(styrenes), such as styrene-containing copolymers, e.g. acrylonitrile-styrene copolymers, styrene-butadiene copolymers, and styrene-vinylbenzylhalide copolymers; polycarbonates; cellulosic polymers, such as cellulose acetate-butyrate, cellulose propionate, ethyl cellulose, methyl cellulose, nitrocellulose; polyamides and polyimides, such as aryl polyamides and aryl polyimides; polyethers; poly(arylene oxides), such as poly(phenylene oxide) and poly(xylene oxide); poly(esteramide-diisocyanate); polyurethanes; polyesters (including polyarylates), such as poly(ethylene terephthalate), poly(alkyl methacrylates), poly(alkyl acrylates), poly(phenylene terephthalate); polysulfides; polymers from monomers having alpha-olefinic unsaturation other than mentioned above such as poly(ethylene), poly(propylene), poly(butene-1), poly(4-methyl pentene-1), polyvinyls, e.g. poly(vinyl chloride), poly(vinyl fluoride), poly(vinylidene chloride), poly(vinylidene fluoride), poly(vinyl alcohol), poly(vinyl esters) such as poly(vinyl acetate), poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; and interpolymers, such as block interpolymers containing repeating units from the above such as terpolymers of acrylonitrile-vinyl bromide-sodium salt of para-sulfophenylmethallyl ethers; and grafts and blends containing any of the foregoing. Such organic polymers can optionally be substituted, for example, with halogens such as fluorine, chlorine, and bromine; hydroxyl groups; lower alkyl groups; lower alkoxy groups; monocyclic aryl; lower acyl groups, and the like. The elongate membrane and the first and the second planar semi-permeable membranes may also include modified versions of organic polymers. For example, organic polymers can be surface modified, surface treated, cross-linked, or otherwise modified following polymer formation. Other types of materials may be used to construct the membrane of the present disclosure and are known to those of ordinary skill in the art.

In some embodiments, each of the first and the second planar semi-permeable membranes 302/304 may be a composite membrane, for example, in a form of a polymer porous layer on top of a non-woven fabric support sheet. Alternatively, the composite membrane may be made out of a polyamide, a polystyrene, or a polypropylene layer, which is deposited on top of a polyethersulfone or polysulfone porous layer on top of a non-woven fabric support sheet.

The elongate membrane 306 and the first and the second planar semi-permeable membranes 302/304 may include micro-pores (i.e. pores with an average pore diameter of less than 2 nm, preferably in the range of 4-12 Å, more preferably 5-10 Å, even more preferably 6-8 Å), meso-pores (i.e. pores with an average pore diameter in the range of 2-50 nm, preferably 5-20 nm), and/or macro-pores (i.e. pores with an average pore diameter of at least 50 nm, or at least 80 nm).

The first and the second planar semi-permeable membranes 302/304 may preferably be substantially the same. As used herein, the term “substantially the same” refers to embodiments where a shape, a geometry, and a material type of the first and the second planar semi-permeable membranes are identical or nearly identical. For example, in some embodiments, each of the first and the second planar semi-permeable membranes has a slab geometry with an aspect ratio (ratio of length to width) in the range of 1:1 to 100:1, preferably 2:1 to 20:1, preferably 3:1 to 10:1, wherein each has a thickness in the range of 1 to 20 mm, preferably 5 to 15 mm, preferably about 10 mm. In some embodiments, a distance between the first and the second planar semi-permeable membranes is in the range of 2 to 50 mm, preferably 3 to 40 mm, preferably 5 to 30 mm. The “distance” as used herein refers to a shortest distance (or a perpendicular distance) between the first and the second planar semi-permeable membranes, and is measured from a surface of the first planar semi-permeable membrane to a surface of the second planar semi-permeable membrane that faces the first planar semi-permeable membrane, and therefore the “distance” does not include the thickness of the first and/or the second planar semi-permeable membranes.

Various means may be adopted to provide mechanical stability to the membrane module. For example, in one embodiment, the membrane module is sandwiched between two layers of a double layered mesh structure. Said mesh structure is configured to secure the membrane module in place within the internal cavity and to provide flexural strength to the membrane module, while allowing water to pass therethrough. Said mesh structure may have a mesh size of less than 5 mm, preferably less than 2 mm. The term “mesh size” as used herein refers to the size of the holes (i.e. meshes) present in said mesh structure, as measured by ASTM E11:01. The term “mechanical stability” as used herein may refer to an enhancement in fracture toughness, flexural modulus, flexural strength, and/or tear strength.

In a preferable embodiment of the invention the first and second planar semi-permeable membranes and the elongated membrane that forms a wall defining the elongated cavity are of sufficient thickness to withstand a hydraulic pressure applied to the saline water which contacts the first and second planar semi-permeable membranes. An increase in the hydraulic pressure on the saline water provides a further driving force to enhance the permeation of water molecules (i.e. solute-free water) through the first and second planar semi-permeable membranes and into the draw solution in the elongated cavity. The elongated membrane must, however, be of sufficient thickness and architecture to withstand the hydraulic pressure of the saline water. Accordingly, the elongated membranes may have a thickness in the range of 1 to 20 mm, preferably 5 to 15 mm, preferably about 10 mm.

Preferably the elongated cavity is cylindrical with a diameter in the range of 0.1 to 5 mm, preferably 0.5 to 4.5 mm, preferably 1.0 to 4.0 mm. In an alternative embodiment, the elongated cavity may be rectangular. Each of the elongated membranes may have a straight cylindrical shape, as shown in FIG. 3C, a U-shape, as shown in FIG. 3D, a zigzag shape, as shown in FIG. 3E, or a coil shape, as shown in FIG. 3F.

In addition, the first and second planar semi-permeable membranes should be sufficiently supported by the elongated membrane to avoid sagging and direct contact between the first and second planar semi-permeable membranes. In view of that, in some preferred embodiments, at least three elongated membranes may be utilized between the first and second planar semi-permeable membranes to avoid sagging. In another preferred embodiment, four elongated membranes are utilized between the first and second planar semi-permeable membranes, as shown in FIG. 3A. Additionally, the elongated membranes must be sufficiently closely packed in the void separating the first and second planar semi-permeable membranes to provide sufficient support so as to prevent sagging and membrane-to-membrane contact between the first and second planar semi-permeable membranes. Accordingly, in some embodiments, the elongated membranes are placed substantially parallel and equidistant to one another, wherein a distance between two adjacent elongated membranes is preferably 10% to 50%, preferably 15% to 45%, preferably 20% to 40% relative to the width of the first and/or the second planar semi-permeable membranes. The distance between two “equidistant” elongated membranes may substantially be the same over an entire length of the elongated membranes. The distance between two adjacent elongated membranes refers to the distance between the centerline axes of the two adjacent elongated membranes.

The water treatment system 100 further includes a draw solution reservoir 104 located upstream of the vessel 102 and fluidly connected to an inlet of the elongated cavity 206 via a draw solution line 120, as shown in FIG. 2. The “draw solution reservoir” refers to a container that contains a draw solution. The draw solution may be stagnant or may be stirred in a continuous fashion in the draw solution reservoir 104, depending on the type of a draw solute present in the draw solution. The draw solution reservoir 104 supplies the draw solution 120s to the elongated cavity when needed.

The term “draw solution” as used in this disclosure refers to a concentrated solution of a draw solute that is preferably dissolved in water, preferably deionized water. The draw solution triggers the forward osmosis by providing an osmotic pressure difference, which induces a flow of water through semi-permeable membranes (i.e. through the first and the second planar semi-permeable membrane and the elongate membrane) into the draw solution. As a result, water is effectively separated from its solute contents, e.g. dissolved salts, etc. Accordingly, when the draw solution is delivered and passed through the elongated cavity of the at least one elongated membrane, water molecules present in the saline water permeate through the first planar semi-permeable membrane 302, the second planar semi-permeable membrane 304, and the at least one elongated membrane 306 to form a mixed water stream 122s comprising water and the draw solute in the elongated cavity.

Type of the draw solute may vary depending on the applications. Accordingly, in some preferred embodiments, the draw solute includes a thermally decomposable (or sublimatable) salt such as ammonium bicarbonate, a volatile solute such as sulfur dioxide or carbon dioxide, a soluble liquid or solid such as aliphatic alcohols, e.g. ethanol, and aluminum sulfate, sugars such as glucose, fructose and sucrose, a polyvalent ionic salt such as potassium nitrate, magnesium chloride, magnesium sulfate, and the like. Further compounds such as ammonia, urea, and ethylene glycol may alternatively be utilized as the draw solute. In some alternative embodiments, magnetic nanoparticles with a hydrophilic peptide attached thereto or a polymer electrolyte such as a dendrimer may be utilized as the draw solute.

In addition, in some embodiments, the water treatment system 100 further includes a separator 106 that is located downstream of the vessel 102 and fluidly connected to an outlet of the elongated cavity 208 via a mixed water line 122, as shown in FIG. 2. Accordingly, the separator 106 separates at least a portion of the draw solute from a mixed water stream 122s that forms inside the elongated membrane. In the separator 106, separation of the draw solute may preferably be carried out via filtration. The filtration means are not particularly limited, and may be a filtration membrane such as a microfiltration membrane, an ultrafiltration membrane, a nanofiltration membrane, or a loose reverse osmosis membrane, a centrifugal separator, or an evaporator. The type of the separator may depend on the draw solute that is utilized. For example, in one embodiment, the draw solute includes a thermally decomposable (or sublimatable) salt such as ammonium bicarbonate and/or a volatile solute such as sulfur dioxide or carbon dioxide, wherein the separator is an evaporator.

The draw solute that is separated may preferably be recycled to the draw solution reservoir 104 with a recycle stream 126s via a recycle line 126. The separator 106 may further include a separator 106 outlet and a purified water line 124 for discharging a purified water stream 124s after separating the draw solute. The types of the separator 106 outlet and the purified water line are not particularly limited.

The inlets and outlets of the at least one elongated membrane may be located on one side of the membrane module or both sides of the membrane module, depending on the shape of the elongated membrane. For example, in some embodiments, the at least one elongated membrane has a U-shape, as shown in FIG. 3D, wherein the inlets and the outlets are located on a same end of the membrane module. Having the inlets and the outlets on one end may provide an extended residence time of the draw solution in the at least one elongated membrane, thus increasing a purified water production yield. In some alternative embodiments, the inlets are located on a first end of the membrane module, and the outlets are located on a second end of the membrane module.

In one embodiment, the water treatment system 100 further includes a pump 127 to pressurize the saline water to enhance the forward osmosis. In one embodiment, the internal cavity is partially filled with the saline water, e.g. less than 90% by volume, or less than 80% by volume and the pump is preferably an air pump that increases saline water overhead pressure, thereby increasing a hydraulic pressure of the saline water. In view of this embodiment, a safety valve may be adopted in the vessel 102 to prevent excessive saline water overhead pressure. Alternatively, a piston may increase the hydraulic pressure of the saline water by exerting a mechanical force on a free surface of the saline water. In another embodiment, the internal cavity is entirely filled with the saline water, e.g. at least 99% by volume, or at least 99.5% by volume, and a water pump 127 is utilized to increase the hydraulic pressure of the saline water. The types of pump that are used here are not limited and various types of pump may be utilized.

The hydraulic pressure of the saline water may vary depending on the TDS content of the saline water, the types of salt present in the saline water, or the types of solute if liquids other than saline water, e.g. blood, are used. For example, in one embodiment, the saline water is seawater, which has an osmotic pressure of around 390 psi, and the pump increases the hydraulic pressure of the saline water to 500 to 1,500 psi, preferably 600 to 1,400 psi, preferably 700 to 1,300 psi, to overcome the osmotic pressure of seawater. In another embodiment, the saline water is brackish water (i.e. having 0.05-3% by weight of dissolved salts), and the pump increases the hydraulic pressure of the saline water to 20 to 500 psi, preferably 30 to 400 psi, preferably 40 to 300 psi to overcome the osmotic pressure of the dissolved salts in the brackish water.

In one embodiment, the water treatment system 100 further includes a saline water tank 108 that is located upstream of and fluidly connected to the saline water inlet 202 via a saline water line 128, and a brine tank 110 that is located downstream of and fluidly connected to the brine outlet 204 via a brine line 130. Alternatively, the saline water may be directly delivered from a sea, an ocean, a river, a lake, etc. via the saline water line 128 and return to the sea, the ocean, the river, the lake, etc. via the brine line 130.

In some embodiments, the membrane may be utilized for separating solute from a blood, wherein the blood is delivered to the vessel 102 from a patient body, and a draw solution is delivered to the membrane module 200. In view of that, a treated blood is returned to the patient body. For example, in some embodiments, the water treatment system 100 may operate as an artificial kidney or a dialyser.

According to a second aspect, the present disclosure relates to a method of forming a purified water stream 124s with the water treatment system 100.

The method involves delivering the draw solution to the elongated cavity. In one embodiment, the draw solution is delivered to the elongated cavity with a flow rate of 0.1 mL/min to 10 L/min, preferably 0.2 mL/min to 5 L/min, preferably 0.3 mL/min to 1.0 L/min. For example, in some embodiments, the water treatment system 100 may operate as an artificial kidney or a dialyser, wherein the draw solution is delivered to the elongated cavity with a flow rate of 0.1 mL/min to 100 mL/min, preferably 0.2 mL/min to 50 mL/min, preferably 0.3 mL/min to 10 mL/min. In some alternative embodiments, the water treatment system may operate as a desalination system, wherein the draw solution is delivered to the elongated cavity with a flow rate of 1 to 10 L/min, preferably 2 to 8 L/min, preferably 3 to 6 L/min.

The draw solution may be delivered to the elongated cavity in a continuous fashion, or in a time-interval fashion. The term “continuous” delivering refers to embodiments where the draw solution is constantly delivered over time, preferably with a constant flow rate. The term “time-interval” delivering refers to embodiments where the draw solution is delivered over a first of time interval and stopped over a second time interval.

The saline water may have a temperature in the range of 10 to 45° C., preferably about to 40° C., preferably 20 to 39° C., and the draw solution may preferably have a temperature in the range of 10 to 45° C., preferably about 15 to 40° C., preferably 20 to 39° C.

As described previously, when the draw solution is delivered and passed through the elongated cavity of the at least one elongated membrane, water molecules present in the saline water permeate through the first planar semi-permeable membrane 302, the second planar semi-permeable membrane 304, and the at least one elongated membrane 306 and the mixed water stream 122s comprising water and the draw solute is formed in the elongated cavity.

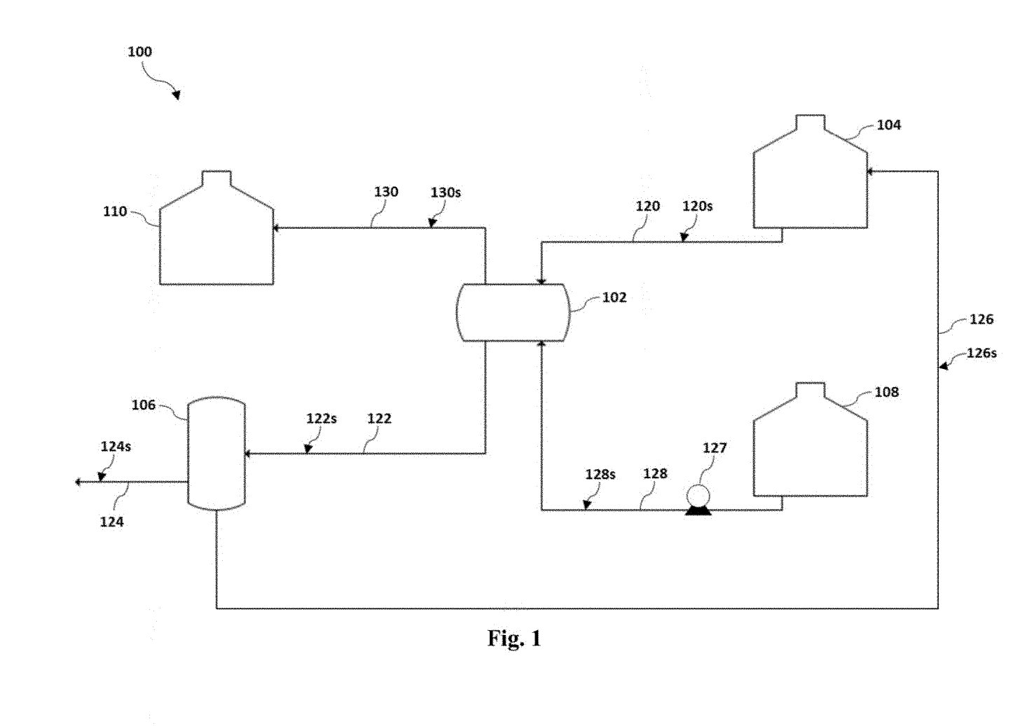

In order to enhance permeation of the saline water through the first planar semi-permeable membrane, the second planar semi-permeable membrane, and the at least one elongated membrane, the saline water may preferably be pressurized to a hydraulic pressure in the range of 30 to 1,500 psi, preferably 40 to 1,400 psi, preferably 50 to 1,300 psi, with the pump. The pump may be a positive displacement water pump 127, as shown in FIG. 1, that is located upstream of the vessel 102 and fluidly connected to the saline water inlet 202, and generates a positive pressure, as shown in FIG. 1. Alternatively, the pump may be a vacuum pump that is located downstream of the vessel 102 and fluidly connected to the brine outlet 204, not shown in FIG. 1. In some embodiments, the pump may be an air pump that increases saline water overhead pressure, thereby increasing a hydraulic pressure of the saline water.

Therefore, in a next step, the method further involves separating the draw solute from the mixed water stream 122s, thereby forming the purified water stream 124s, which may be collected from the purified water line 124. The purified water stream 124s may be further processed to be utilized for drinking, or may be used in air conditioning or refrigerating systems in residential or industrial applications. The purified water stream may further be delivered to petrochemical or chemical manufacturing plants to be utilized as distilled water for various chemical reactions or other applications known to those skilled in the art. In the embodiments where the water treatment system 100 operates as an artificial kidney or a dialyser, the treated blood may be delivered to the patient body after separating the draw solute. Preferably, the water treatment system 100 may produce the purified water stream 124s with a production rate of 10 to 500,000 BPD (barrel per day), preferably 100 to 50,000 BPD, preferably 1,000 to 20,000 BPD. Alternatively, in the embodiments where the water treatment system 100 operates as an artificial kidney or a dialyser, production rate (i.e. purification rate) of the treated blood may vary in the range of 0.1 to 500 mL/min, preferably 1.0 to 200 mL/min, preferably 2.0 to 100 mL/min.

In one embodiment, a total dissolved solid present in the purified water stream 124s may be about 60% to about 99%, preferably about 65% to about 98%, preferably about 70% to about 96% lower than the total dissolved solid present in the saline water 128s. For example, in one embodiment, a total dissolved solid present in the saline water 128s is in the range of about 1,000 to 50,000 ppm, preferably about 2,000 to 45,000 ppm, preferably about 3,000 to 40,000 ppm, whereas a total dissolved solid present in the purified water stream 124s is in the range of about 100 to 5,000 ppm, preferably about 200 to 1,000 ppm, preferably about 300 to 500 ppm. In the embodiments where the water treatment system 100 operates as an artificial kidney or a dialyser, a treated blood or a treated liquid may have a total solute of no more than 2%, preferably no more than 1%, preferably no more than 0.5% relative to the total solute present in an untreated blood or an untreated liquid. For example, in one embodiment, a total solute content of a blood varies in the range of about 10 to 1,000 ppm, preferably about 20 to 500 ppm, preferably about 30 to 400 ppm, whereas total solute content of a treated blood may reduce to a value in the range of about 1 to 100 ppm, preferably about 2 to 50 ppm, preferably about 3 to 20 ppm. In addition to the solute, solid particles that are suspended in water/blood with an average particle size of more than 50 nm, preferably more than 40 nm, may also be filtered. In view of that, the water treatment system 100 may filter microorganisms and bacteria.

In one embodiment, a portion of the draw solute may preferably be recycled to the draw solution reservoir 104 via the recycle line 126.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1: A water treatment system, comprising:
a vessel with an internal cavity, a saline water inlet, and a brine outlet, wherein the vessel contains a saline water,
a membrane module that is disposed in the internal cavity and submerged in the saline water, wherein the membrane module comprises
a first planar semi-permeable membrane,
a second planar semi-permeable membrane that is placed substantially parallel to the first planar semi-permeable membrane, and
at least one elongated membrane with an elongated cavity, wherein the at least one elongated membrane is sandwiched between the first and the second planar semi-permeable membranes; and
a draw solution reservoir located upstream of the vessel and fluidly connected to an inlet of the elongated cavity via a draw solution line, wherein the draw solution reservoir delivers a draw solution comprising a draw solute to the elongated cavity,
wherein water molecules present in the saline water permeate through the first planar semi-permeable membrane, the second planar semi-permeable membrane, and the at least one elongated membrane to form a mixed water stream comprising water and the draw solute in the elongated cavity.

2: The water treatment system of claim 1, further comprising:
a separator that is located downstream of the vessel and fluidly connected to an outlet of the elongated cavity via a mixed water line, wherein the separator separates at least a portion of the draw solute from the mixed water stream.

3: The method of claim 2, wherein the separator comprises at least one of a microfiltration membrane, an ultrafiltration membrane, a nanofiltration membrane, and a centrifugal separator.

4: The water treatment system of claim 1, wherein the at least one elongated membrane has a coil shape.

5: The water treatment system of claim 1, wherein the at least one elongated membrane has a zigzag shape.

6: The water treatment system of claim 1, wherein the first and the second planar semi-permeable membranes are substantially the same.

7: The water treatment system of claim 1, wherein a distance between the first and the second planar semi-permeable membranes is in the range of 2 to 50 mm.

8: The water treatment system of claim 1, wherein each of the first and the second planar semi-permeable membrane has a thickness of 1 to 20 mm.

9: The water treatment system of claim 1, wherein the at least one elongated membrane has a thickness of 1 to 20 mm.

10: The water treatment system of claim 1, wherein the elongated cavity is cylindrical with a diameter in the range of 0.1 to 5 mm.

11: The water treatment system of claim 1, wherein the draw solute is at least one compound selected from the group consisting of ammonia, aluminum sulfate, glucose, fructose, sucrose, ethanol, urea, and ethylene glycol.

12: The water treatment system of claim 1, wherein each of the first planar semi-permeable membrane, the second planar semi-permeable membrane, and the at least one elongated membrane comprises at least one polymer selected from the group consisting of polyamide, polystyrene, polyethersulfone, and polysulfone.

13: The water treatment system of claim 1, further comprising:
a pump disposed in the internal cavity to pressurize the saline water.

14: The water treatment system of claim 1, further comprising:
a saline water tank that is located upstream of and fluidly connected to the saline water inlet via a saline water line; and
a brine tank that is located downstream of and fluidly connected to the brine outlet via a brine line.

15: A method of forming a purified water stream with the water treatment system of claim 2, comprising:
delivering the draw solution to the elongated cavity so that water molecules present in the saline water permeate through the first planar semi-permeable membrane, the second planar semi-permeable membrane, and the at least one elongated membrane to form a mixed water stream comprising water and the draw solute in the elongated cavity; and
separating the draw solute from the mixed water stream, thereby forming the purified water stream.

16: The method of claim 15, wherein the draw solution is delivered to the elongated cavity with a flow rate of 0.1 mL/min to 10 L/min.

17: The method of claim 15, wherein the draw solution is delivered to the elongated cavity in a continuous fashion.

18: The method of claim 15, further comprising:
recycling a portion of the draw solute to the draw solution reservoir.

19: The method of claim 15, further comprising:
pressurizing the saline water after the delivering.

20: The method of claim 19, wherein the saline water is pressurized to a hydraulic pressure of 30 to 1,500 psi.
